(19) United States
(12) Patent Application Publication
(10) Pub. No.: US 2018/0086892 A1
(43) Pub. Date: Mar. 29, 2018

(54) Use of Novel catalyst and method for treating PCB inked polymer waste by the novel catalyst

(71) Applicant: Ciphore Biomed Technology Limited Company, Taipei City (TW)

(72) Inventor: Chien-Tien CHEN, Hsinchu County (TW)

(21) Appl. No.: 15/646,156

(22) Filed: Jul. 11, 2017

(30) Foreign Application Priority Data
Sep. 23, 2016 (TW) 105130723

(51) Int. Cl. C08J 11/16; B01J 27/132; B01J 27/10; B01J 27/053; B01J 27/135; B01J 27/128; B01J 27/055; B01J 31/02; B01J 31/04

(52) U.S. Cl. CPC C08J 11/16; B01J 27/132; B01J 27/10; B01J 27/053; B01J 27/135; B01J 27/128; C08J 2300/30; B01J 31/0212; B01J 31/0232; B01J 31/04; B01J 2231/005; B01J 2531/004; B01J 27/055

(57) ABSTRACT

A novel catalyst, a use thereof and a method for treating PCB inked waste by using the same are disclosed. The catalyst of the present disclosure is represented by the following formula (I):

[M(O)ₐ]^{m+}Xⁿ⁻ (I)

herein M, X, a, m and n are defined in the specification.

### CROSS REFERENCE TO RELATED APPLICATION

This application claims the benefits of the Taiwan Patent Application. Serial Number 105130723, filed on Sep. 23, 2016, the subject matter of which is incorporated herein by reference.

### BACKGROUND

### 1. Field

A novel catalyst is disclosed and, particularly to a novel catalyst capable of treating a PCB (printing circuit board) inked photo-cured and binder polymer waste. In addition, a use of the catalyst and a method for treating a PCB inked polymer waste using the catalyst are also disclosed.

### 2. Description of Related Art

Print circuit boards (PCBs) are important units used in various commercial electronic devices in the field of information, communication and so on. In recent decades, large amounts of PCBs are produced and used, resulting in large amounts of PCB wastes generated. The PCB wastes contain not only photo-cured and/or thermal setting materials such as acrylic and epoxy resins but also initiators, inks, dyes, glass fibers, and chemical materials containing Cu, heavy metals and toxic perhaloaryls (such as chlorides). If the PCB wastes are thrown away arbitrarily, severe environmental pollutions are occurred. In addition, it is difficult to recycle thermal setting and/or photo-cured materials such as acrylic and epoxy resins. Hence, recycling pure polymers from PCB wastes (such as metal sludge and photo-curing smear residue) with complete decomposition of hazardous dyes and inks becomes one important and difficult environmental issue.

Large amounts of ink and dyes are used in the production of PCBs. The used inks can be classified into seven types according to their functions and usages: anti-etching inks, plating-resistant inks, hole plugging ink, solder-resistant inks (also named as green paint), mark inks, conductive ink and strippable inks (also named as blue paint). The main components of the inks are consisted of resins, fillers, dyes, additives and solvents. The redundant inks can be removed by NaOH solution. The ink waste water is basic and contains high concentration of organic materials. The ink waste water contains large amounts of resins, and the resins are easily precipitated under an acid condition.

PCB ink waste water is waste water with high concentration of organic contaminants. Potassium dichromate was used as an oxidant to determine its chemical oxygen consumption. Dichromate chemical oxygen demand (COD_{Cr}) in the PCB ink waste water usually is 5,000-10,000 mg/L, and sometimes is as high as 20,000 mg/L. Suspended solids (SS) in the PCB ink waste is about 800-1,200 mg/L. The pH value of the PCB ink waste is generally basic. The PCB ink waste is present in dark blue. The amount of the PCB ink waste is about 5% of the total amount of the PCB waste water. For the treatment of the PCB waste water, the key factor that whether COD_{Cr} can achieve the standard allowance (≧100 mg/L) is the effective removing percentage of the high concentration organic material in the ink waste water. Conventional methods for treating PCB ink waste water include: oxidation methods, biological treatments, filtration-adsorption methods, acidification-coagulation methods and so on. The aforesaid methods are aimed to the high concentration organic materials in the ink waste water, and performed by filtering ink residues or glue residues out, followed by performing physical or chemical treatment. However, the aforesaid methods are complicated, and solid wastes containing resins and inks with odor smell are generated. In addition, according to the list of National Hazardous Wastes in China, the wastes are classified into HW 13, and have to be treated with burning or berried in land field. However, the former process would generate dioxoin-related perchloroaryls and later case tends to cause serious contamination to rivers, farm lands, and ultimately cause accumulations in grain and vegetable products.

Therefore, it is desirable to provide a method for treating a PCB inked polymer waste, which can solve the problems of the environmental pollution caused by the PCB waste and at the same time recover pure polymers for subsequent paint and dispersant applications.

### SUMMARY

An objective of the present disclosure is to provide a catalyst and its use thereof. The catalyst of the present disclosure can degrade various inks, dyes, and initiators into water soluble materials, or recycling of and transforming polymers into reusable materials of commercial values.

Another objective of the present disclosure is to provide a method for treating a PCB inked polymer waste, which can effectively treat the inks and polymers in the PCB inked polymer waste to achieve the purpose of degrading, recycling or modifying the polymers in the PCB.

The catalyst of the present disclosure is represented by the following formula (I):

[M(O)ₐ]^{m+}Xⁿ⁻ (I)

wherein M is an element of Group IB, Group IVB, Group VB, Group VIB, Group VIIB or Group VIIIB;

X is Cl, Br, I, OAc, OC(O)(CF₂)ₙCF₃, OC(O)C₁₂H₂₅, [OSO₂C₆H₄-CHCH₂]ₙ, OTf, OSO₂C₆H₄-Me (OTs), SO₄, SO₃C₁₂H₂₅ or acetylacetonate (acac);

a is an integral of 0 to 3;

m is an integral of 2 to 4; and

n is an integral of 1 or 2.

Herein, the formula of [OSO₂C₆H₄-CHCH₂]ₙ is

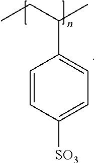

In addition, the present disclosure further provides a use of the catalyst represented by the aforesaid formula (I) for degrading inks, or modifying (e.g, acylating) or recycling polymers.

Furthermore, the present disclosure also provides a method for treating a PCB inked polymer waste, comprising the following steps: mixing a PCB inked polymer waste, the catalyst representing by the aforesaid formula (I), a reagent and a first solvent to obtain a mixture; reacting the mixture at a predetermined temperature to obtain a reacted mixture; and adding the reacted mixture into a second solvent.

When the catalyst of the formula (I) is used to treat the PCB, the inks can be effectively degraded into water soluble materials to meet the requirement of environmental protection. In addition, photo-initiators, dyes and plasticizer contained in the PCB can be degraded; and polymer resins can be recycled into acrylic and/or epoxy resins or acylated into an acylated polymer capable of being dissolved in conventional organic solvents. Therefore, the purposes of recycling and reusing can be achieved.

In the present disclosure, the types of the inks are not particularly limited, and can be green and/or blue inks. Specific examples of the inks include, but are not limited to: phthalocyanine derivatives, azo pigment derivatives and so on.

In the catalyst represented by the formula (I) of the present disclosure, a can be 0, and M can be Ti (IV), Zr (IV), Hf (IV), V (III), Fe (II)/(III), Cu (I/II), or Mn (II/III).

In the catalyst represented by the formula (I) of the present disclosure, M(O)ₐ can be VO, VO₃, ZrO, HfO, WO₂, MoO₂, CrO₂ or ReO₃.

Specific examples of the catalyst represented by the formula (I) of the present disclosure include, but are not limited to Hf(O)Cl₂, V(O)Cl₂, V(O)[(O₃ SC₆H₄CHCH₂)ₙ]₂, V(O)Cl₂, V(O)(OTf)₂, V(O)(COCF₃)₂, MoO₂Cl₂, Mn(O)(OAc), FeCl₃, Zr(O)Cl₂, Ti(O)(acac)₂, V(O)SO₄, V(O)(acac)₂, MoO₂(acac)₂, Mn(II)SO₄, or FeSO₄. In addition, the aforementioned catalysts can be used alone or in combination.

In the method for treating the PCB inked polymer waste of the present disclosure, the used reagent can be an anhydride-based compound, a sulfonic anhydride-based compound, an acyl halide-based compound, a sulfonyl halide-based compound, an oxidant or a combination thereof.

The anhydride-based compound can be represented by the following formula (II):

R₁C(O)OC(O)R′₁ (II)

wherein each R₁ and R′₁ independently is C₁-C₆ alkyl, CF₃, C₂F₅, C₃F₇ or aryl.

The sulfonic anhydride-based compound can be represented by the following formula (III):

R₂SO₂OSO₂R′₂ (III)

wherein each R₂ and R′₂ independently is C₁-C₆ alkyl, CF₃, C₂F₅, C₃F₇ or aryl.

The acyl halide-based compound can be represented by the following formula (IV):

R₃C(O)X′ (IV)

wherein R₃ is C₁-C₆ alkyl, CF₃, C₂F₅, C₃F₇ or aryl; and X′ is Cl or Br.

The sulfonyl halide-based compound can be represented by the following formula (V):

R₄SO₂X″ (V)

wherein R₄ is C₁-C₆ alkyl, CF₃, C₂F₅, C₃F₇ or aryl; and X″ is Cl or Br.

The oxidant can be peroxy acid-based compounds, peroxysulfate based compounds, NaOCl, NaO₂Cl, NaO₃Cl, NaO₄Cl, H₂O₂, H₂O₂-urea, t-BuOOH, cumene-OOH, or Ar₃COOH. Herein, the peroxyacid-based compound can be represented by the following formula (VIA):

R₅C(O)OOH (VIA)

wherein R₅ is C₁-C₆ alkyl, CF₃, C₂F₅, C₃F₇ or aryl.
Herein, the peroxy sulfate-based compounds can be represented by the following formula (VIB):

MOSO₂OOH (VIB), and M can be Na or K.

In addition, in the method for treating the PCB inked polymer waste of the present disclosure, the first solvent can be a carboxylic acid-based solvent, a sulfonic acid-based solvent, a phosphoric acid solvent or a combination thereof. Herein, examples of the carboxylic acid-based and the sulfonic acid-based solvent can be respectively represented by the following formulas (VII) and (VIII):

R₆CO₂H (VII)

wherein R₆ is C₁-C₆ alkyl, CF₃, C₂F₅, C₃F₇ or aryl;

R₇SO₃H (VIII)

wherein R₇ is C₁-C₆ alkyl, CF₃, C₂F₅, C₃F₇ or aryl.

In the method for treating the PCB inked polymer waste of the present disclosure, the types of the second solvent are not particularly limited, and the main purpose of the second solvent is used to wash the reacted mixture. Examples of the second solvent can be water, alcohols (for example, methanol, ethanol, (iso)propanol, (iso)butanol, and tert-butanol), acetic acid or a combination thereof.

In the method for treating the PCB inked polymer waste of the present disclosure, the predetermined temperature of the reaction is not particularly limited, as long as the predetermined temperature can facilitate the reaction. For example, the predetermined temperature can be between 40° C. and 110° C.

In the method for treating the PCB inked polymer waste of the present disclosure, the used amount of the catalyst is not particularly limited, as long as the inks can be degraded or the polymers can be acylated. For example, the amount of the catalyst is 0.5-10 wt % of a total weight of the mixture.

Other objects, advantages, and novel features of the disclosure will become more apparent from the following detailed description when taken in conjunction with the accompanying drawings.

### BRIEF DESCRIPTION OF THE DRAWINGS

FIG. 1 and FIG. 2 are ¹H NMR spectra of porducts generated at different stages according to Example 1 of the present disclosure.

FIG. 3 is a ¹H NMR spectrum of a product of Example 2 of the present disclosure.

### DETAILED DESCRIPTION OF EMBODIMENT

The following embodiments when read with the accompanying drawings are made to clearly exhibit the above-mentioned and other technical contents, features and effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Catalyst Synthesis

In the present embodiment, the catalyst can be synthesized according to the following equations.

V(O)SO₄(aq)+BaX₂(aq)→V(O)X₂(aq)+BaSO₄(s)

V(O)SO₄(aq)+Ba(OAc)₂(aq)→V(O)(OAc)₂(aq)+BaSO₄(s)

V(O)SO₄(aq)+Ba(OTf)₂(aq)→V(O)(OTf)₂(aq)+BaSO₄(s)

V(O)SO₄(aq)+Ba(OTs)₂(aq)→V(O)(OTs)₂(aq)+BaSO₄(s)

V(O)SO₄(aq)+Ba[(O₃SC₆H₄CHCH₂)ₙ]₂(aq)→V(O)[(O₃SC₆H₄CHCH₂)ₙ]₂(aq)+BaSO₄(s)

2.5 mmol VOSO₄-5H₂O was placed into a dried two-neck round-bottom flask (50 mL), followed by adding anhydrous MeOH (2.5 mL). At room temperature, a methaol solution (2.5 mL) containing 2.5 mmol (1 equiv) BaX₂ (for example, Ba(OAc)₂, BaOTs₂, BaOTf₂ or Ba[(O₃SC₆H₄CHCH₂)ₙ]₂) was slowly added into the obtained solution. After stirring for 30 mins, the reacting mixture was turbid with a great mound of BaSO₄ percipitated. The mixture was filtered through a celite plug. The obained filtrate was evaporated, and a dark blue solid was obtained. The obtained solid was dried at 120° C., under vaccum for 4 hrs. The obtained product can be stored in a dry box at room temperature for several weeks, and can be used directly.

In the following examples of the present disclosure, the main reactions can be represented by the following schemes I and II.

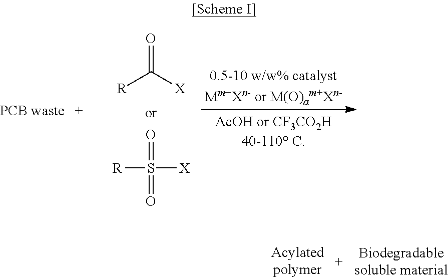

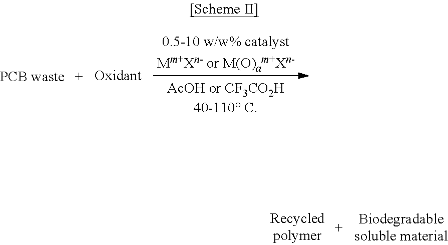

### EXAMPLE 1

Under N₂ atmosphere, PCB waste (10 g, which comprises copolymer (HW-12 or HW-13), ink (Phthalocyanine) and plasticizer (Bis(2-ethylhexyl)phthalate, DEI-IP)) was added into acetic acid (50 ml) in a two-neck flask (250 ml). Then, the catalyst (0.5 g) and acetic anhydride (10 ml) was added. The mixture was heated to 100° C. After 56-60 hrs, the solution containg the PCB waste was transformed from sky blue into reddish brown, and the solid was white. The catalyst (catalyst A) can be, for example, Hf(O)Cl₂ (Group IVB), V(O)Cl₂ or V(O)(OTf)₂ (Group VB), MoO₂C₂ (Group VIB), Mn(O)(OAc) (Group VIIB), or FeCl₃ (Group VIIIB). Herein, the used catalyst was MoO₂Cl₂.

After the reaction was completed, additional cooling step was not required. 2 ml reactant was added into 25 ml water and stirred for 10-20 mins. When there was no dyed or colored reactant, the reaction was determind to be complete. Then, the reaction mixture was slowly added into 200 ml water dropwise and smashed with a juice blender. The collected solid was added into 200 ml water, followed by stirring for 30 mins to remove acid and prevent polymer aggregation.

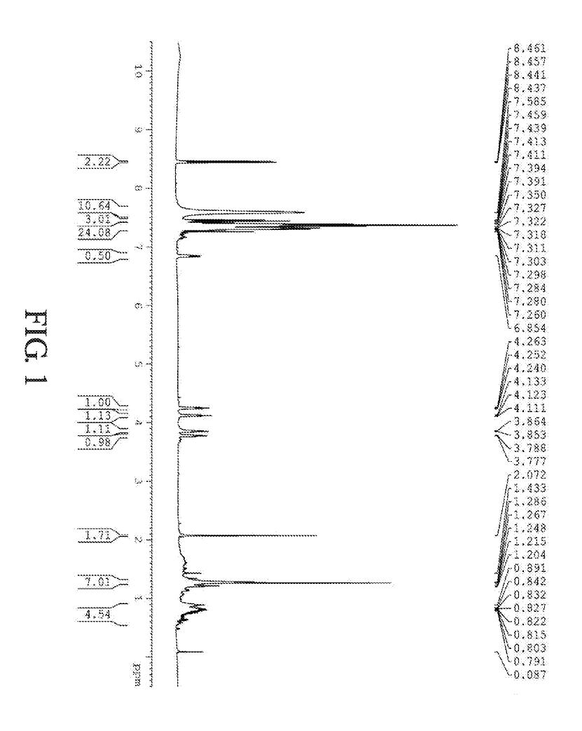

After collecting the solid and removing water, the clleceted solid was washed with 50 ml methanol (PCB:MeOH=1:5). After filtration, small molecules removed by the methanol was detected by TLC visualization method. After drying of the methanol solution, the obtained powders were dissolved in CDCl₃, and the ¹H NMR thereof is shown in FIG. 1.

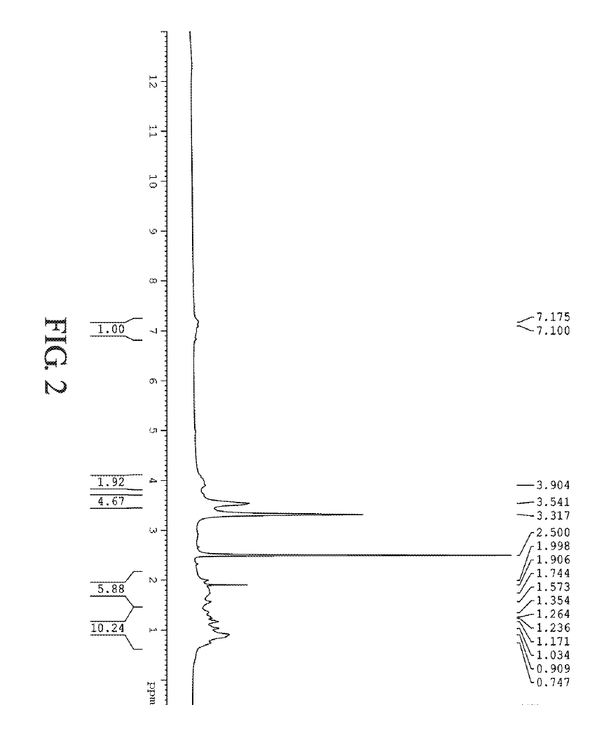

After removing methanol, the polymer product was dissolved with 50 ml acetic acid (product: acetic acid=1:5), followed by adding into 200 ml water. After filtering and drying, light yellow powders were obtained (weight=8.678 g, number average moleculer weight (Mₙ)=9,805, wight average molecular weight (M_{w})=15,235, and polydisepersity index (PDI)=1.55). In addition, the obtained powders were dissolved in d₆-DMSO, and the ¹H NMR spectrum thereof is shown in FIG. 2.

The results indicate that the inks can be degraded and the polymer can be acylated successfully when using the catalyst and the anhydride of the present disclosure.

### EXAMPLE 2

Under N₂ atmosphere, PCB waste (10 g, which comprises copolymer (HW-12 or HW-13), ink (Phthalocyanine) and plasticizer (DEHP)) was added into acetic acid (50 ml) in a two-neck flask (250 nil), and the PCB waste was smashed with a juice mixer for 30 sec. Then, the catalyst (100 mg) and CH₃COCl (25 ml) was added therein, and the mixture was heated to 60-70° C. The reaction progress was detected with TLC plates, wherein 1 ml reactant was added into 25 ml water at diferent time points (6, 12, 18, 24 and 40 hrs). The solution color containing the PCB waste was transformed from sky blue into reddish brown, and the polymer was precipitated and turned into white. In this step, the catalyst A shown in Example 1 can be used. Herein, the used catalyst was V(O)Cl₂.

Next, the reactant was added into water to preceed with the subsequent color removing step. First, 1 ml acetic acid and 5 g another catalyst was added in the mixture, followed by adding 5 ml 35% H₂O₂ after 1 hrs and stirring the mixture for 12-16 hrs. The catalyst (catalyst B) capable of using in this step can be, for exmaple, Zr(O )Cl₂ or Ti(O)(acac)₂ (Group IVB), V(O)SO₄ or V(O)(acac)₂ (Group VB), MoO₂(acac)₂ (Group VIB), Mn(II)SO₄ (Group VIIB), or FeSO₄ (Group VIIIB). Herein, the used catalyst was V(O)SO₄.

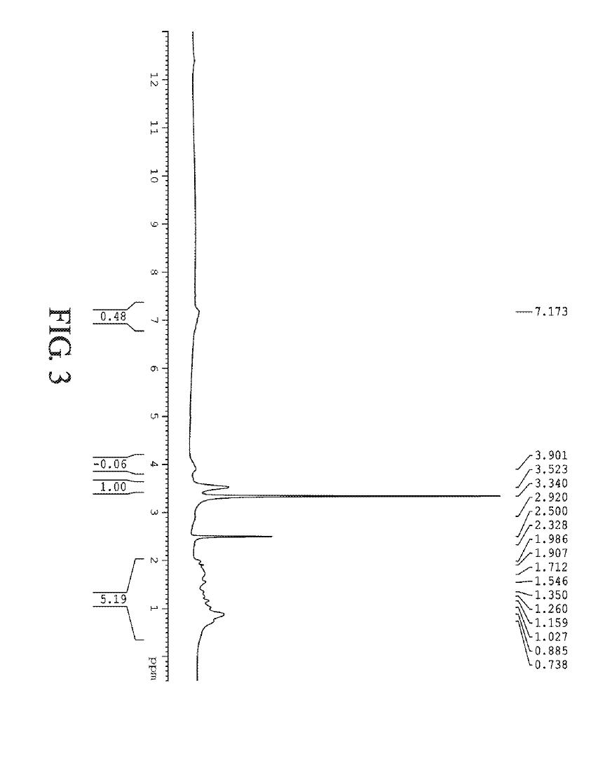

After filterring and drying, white powders can be obtained (weight=6.9170 g), and the recyling yield was determined to be 69.2%. Then, the white powders was added into 30-40 ml methanol. After filtration, the residue was dissolved in 30-40 ml acetic acid. Then, the solution was added into 100 ml deionized water. After filtrating and drying, white solid was obtained (number average molecular weight (Mₙ)=8,605, weight average molecular weight (M_{w})=12,355, and polydisepersity index (PDI)=1.55), and the recyling yield was determined to be 81.3%. The obtained powders were dissolved in d₆-DMSO, and the ¹H NMR spectrum thereof is shown in FIG. 3.

The results indicate that the polymer can be acylated successfully when using the catalyst and the anhydride of the present disclosure. In addition, the inks can be degraded by using the catalyst and the oxidant of the present disclosure.

### EXAMPLE 3

Wet PCB waste (100 g, which comprises copolymer (HW-12 or HW-13), ink (Phthalocyanine) and plasticizer (DEHP)) was dissolved in acetic acid (100 ml), and the PCB waste was smashed with a juice mixer. The PCB waste was turned into dark blue when contacting the acetic acid. Then, a mixture containing 5 g catalyst and oxidant t-BuOOH (1:50˜1:100) was heated to 55-60° C. The reaction progress was detected with TLC plates, wherein the fluorence of the ink was faded gradually. After reacting for 10-12 hrs, the reactant was turned from dark blue into reddish brown. 5 mL 35% H₂O₂ was added into the reaction every hour for three times. After reacting for another 12 hrs, the reatnat was turned from reddish brown into light yellow or milky white. In this step, the catalyst B shown in Example 2 can be used. Herein, the used catalyst was V(O)SO₄.

Finally, the reaction mixture was added into 100 ml deionized water. After filtrating and drying, white solid can be obatained (number average molecular weight (Mₙ)=11,767, weight average molecular weight (M_{w})=18,046, and polydiseperse index (PDI)=1.53), and the recyling rate was determined to be 65.6%.

The results indicate that the inks can be degraded and the pure polymer can be recylced successfully when using the catalyst and the oxidant of the present disclosure.

### EXAMPLES 4-8

In the present examples, the procedures were similar to that shown in Example 2, except that the catalyst A and the catalyst B were replaced by the catalysts listed in the following Table 1.

TABLE 1

| | Catalyst A | Catalyst B |
|---|---|---|
| Example 4 | MoO₂Cl₂ | MeReO₃ |
| Example 5 | ZrOCl₂ | V(O)(OTf)₂ |
| Example 6 | V(O)Cl₂ | FeSO₄ |
| Example 7 | FeCl₂ | MnSO₄ |
| Example 8 | CuSO₄ | V(O)(OAc)₂ |

As shown in the aforesaid examples, simple solvents (such as acetic acid) and simple acetylation reagents are used in the method of the present disclosure. In addition, whether the ink is degraded or not can be determined by observing the color change of the reaction mixture and solution with naked eyes.

When the catalyst of the present disclosure is used, the inks can be completely degraded into water soluable waste to meet the requirement of the environmental protection. Meanwhile, the initiators, the dyes and the plasticizer contained in PCB can be degraded, and the polymer resin can be recyled into acrylic and/or epoxy resin. Alternatively, the polymer can be acylated into acylated polymer capable of dissloving in conventional organic solvents, recyled and reused. The yield of the acrylic and/or epoxy resin (the recycling rate of PCB) can reach 60-70%, and yield of the acylated polymer (the recycling rate of PCB) can also be 60-70%. Hence, the catalyst of the present disclosure can effectively treat large amounts of inked PCB waste and the present disclosure can achieve the purpose of recyling polymers.

Although the present disclosure has been explained in relation to its embodiment, it is to be understood that many other possible modifications and variations can be made without departing from the spirit and scope of the disclosure as hereinafter claimed.

What is claimed is:

1. A catalyst, representing by the following formula (I):
[M(O)ₐ]^{m+}Xⁿ⁻ (I)
wherein M is an element of Group IB, Group IVB, Group VB, Group VIB, Group VIIB or Group VIIIB;
X is Cl, Br, I, OAc, OC(O)(CF₂)ₙCF₃, OC(O)C₁₂H₂₅, [(OSO₂C₆H₄-CHCH₂)ₙ], OTf, OTs, SO₄, SO₃C ₂H₂₅ or acetylacetonate (acac);
a is an integral of 0 to 3;
m is an integral of 2 to 4; and
n is an integral of 1 or 2.

2. The catalyst of claim 1, wherein a is 0, and M is Ti, Zr, Hf, V, Fe, Cu or Mn.

3. The catalyst of claim 1, wherein M(O)ₐ is VO, VO₃, ZrO, HfO, WO₂, MoO₂, CrO₂ or ReO₃.

4. A use of a catalyst for degrading inks or acylating or recycling polymers, wherein the catalyst is representing by the following formula (I):
[M(O)ₐ]^{m+}Xⁿ⁻ (I)
wherein M is an element of Group IB, Group IVB, Group VB, Group VIB, Group VIIB or Group VIIIB;
X is Cl, Br, I, OAc, OC(O)(CF₂)ₙCF₃, OC(O)C₁₂H₂₅, [(OSO₂C₆H₄-CHCH₂)ₙ], OTf, OTs, SO₄, SO₃C₁₂H₂₅ or acetylacetonate (acac);
a is an integral of 0 to 3;
m is an integral of 2 to 4; and
n is an integral of 1 or 2.

5. A method for treating a PCB inked polymer waste, comprising the following steps:
mixing a PCB inked polymer waste, a catalyst representing by the following formula (I), a reagent and a first solvent to obtain a mixture:
[M(O)ₐ]^{m+}Xⁿ⁻ (I)
wherein M is an element of Group IB, Group IVB, Group VB, Group VIB, Group VIIB or Group VIIIB;
X is Cl, Br, I, OAc, OC(O)(CF₂)ₙCF₃, OC(O)C₁₂H₂₅, [(OSO₂C₆H₄-CHCH₂)ₙ], OTf, OTs, SO₄, SO₃C₁₂H₂₅ or acetylacetonate (acac);
a is an integral of 0 to 3;
m is an integral of 2 to 4; and
n is an integral of 1 or 2;
reacting the mixture at a predetermined temperature to obtain a reacted mixture; and
adding the reacted mixture into a second solvent.

6. The method of claim 5, wherein the reagent is an anhydride-based compound, a sulfonic anhydride-based compound, an acyl halide-based compound, a sulfonyl halide-based compound, an oxidant, or a combination thereof.

7. The method of claim 6, wherein the anhydride-based compound is represented by the following formula (II):
R₁C(O)OC(O)R′₁ (II)
wherein each R₁ and R′₁ independently is C₁-C₆ alkyl, CF₃, C₂F₅, C₃F₇ or aryl.

8. The method of claim 6, wherein the sulfonic anhydride-based compound is represented by the following fora ula (III):
R₂SO₂OSO₂R′₂ (III)
wherein each R₂ and R′₂ independently is C₁-C₆ alkyl, CF₃, C₂F₅, C₃F₇ or aryl.

9. The method of claim 6, wherein the acyl halide-based compound is represented by the following formula (IV):
R₃C(O)X′ (IV)
wherein R₃ is C₁-C₆ alkyl, CF₃, C₂F₅, C₃F₇ or aryl; and
X′ is Cl or Br.

10. The method of claim 6, wherein the sulfonyl halide-based compound is represented by the following formula (V):
R₄SO₂X″ (V)
wherein R₄ is C₁-C₆ alkyl, CF₃, C₂F₅, C₃F₇ or aryl; and
X″ is Cl or Br.

11. The method of claim 6, wherein the oxidant is peroxy acid-based compounds, peroxy sulfate-based compounds, NaOCl, NaO₂Cl, NaO₃Cl, NaO₄Cl, H₂O₂, H₂O₂-urea, t-BuOOH, cumene-OOH, or Ar₃COOH.

12. The method of claim 11, wherein the peroxy acid-based compound is represented by the following formula (VIA):
R₅C(O)OOH (VIA)
wherein R₅ is C₁-C₆ alkyl, CF₃, C₂F₅, C₃F₇ or aryl.
wherein the peroxy sulfate-based compound is represented by the following formula (VIB):
MOSO₂OOH (VIB)
wherein M is Na or K.

13. The method of claim 5, wherein the first solvent is a carboxylic acid-based solvent, a sulfonic acid-based solvent, a phosphoric acid solvent or a combination thereof.

14. The method of claim 13, wherein the carboxylic acid-based solvent is represented by the following formula (VII):
R₆CO₂H (VII)
wherein R₆ is C₁-C₆ alkyl, CF₃, C₂F₅, C₃F₇ or aryl..

15. The method of claim 13, wherein the sulfonic acid-based solvent is represented by the following formula (VIII):
R₇SO₃H (VIII)
wherein R₇ is C₁-C₆ alkyl, CF₃, C₂F₅, C₃F₇ or aryl.

16. The method of claim 5, wherein the second solvent is water, alcohol, acetic acid or a combination thereof.

17. The method of claim 5, wherein the predetermined temperature is between 40° C. and 110° C.

18. The method of claim 5, wherein an amount of the catalyst is 0.5-10 wt % of a total weight of the mixture.

19. The method of claim 5, wherein in the formula (I), a is 0, and M is Ti, Zr, Hf, V, Fe, Cu or Mn.

20. The method of claim 5, wherein in the formula (I), M(O)ₐ is VO, VO₃, ZrO, HfO, WO₂, MoO₂, CrO₂ or ReO₃.
